(19) United States
(12) Patent Application Publication
(10) Pub. No.: US 2024/0051575 A1
(43) Pub. Date: Feb. 15, 2024

(54) AUTONOMOUS VEHICLE TESTING OPTIMIZATION USING OFFLINE REINFORCEMENT LEARNING

(71) Applicant: GM Cruise Holdings LLC, San Francisco, CA (US)

(72) Inventor: Ritchie Lee, Sunnyvale, CA (US)

(21) Appl. No.: 17/887,290

(22) Filed: Aug. 12, 2022

(51) Int. Cl. B60W 60/00; G06N 20/00; B60W 50/02; B60W 50/00; B60W 50/06

(52) U.S. Cl. CPC B60W 60/0015; G06N 20/00; B60W 50/0205; B60W 50/0098; B60W 50/06; B60W 2556/45

(57) ABSTRACT

The disclosed technology provides solutions for improving autonomous vehicle (AV) testing and in particular, for improving AV adversarial testing using offline reinforcement learning. In some aspects, the disclosed technology includes a process for improving AV adversarial testing, including steps for receiving driving data from a database, the driving data representing a plurality of driving scenarios encountered by AVs and training an offline reinforcement learning agent with the driving data. Further, the process includes steps for receiving a driving scenario from the database, calculating a first safety score for the driving scenario, providing the driving scenario to an offline reinforcement learning model, and generating a synthetic scenario for simulating navigation of an AV, the synthetic scenario having a second safety score that is lower than the first safety score.

### BACKGROUND

### 1. Technical Field

The present disclosure generally relates to the optimization of autonomous vehicle testing using offline reinforcement learning and, more specifically, optimization of autonomous vehicle adversarial testing using offline reinforcement learning.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a simulation framework architecture, according to some examples of the present disclosure;

FIG. 2 illustrates a flow diagram of simulation scenario generation framework using reinforcement learning, according to some examples of the present disclosure;

FIG. 3 illustrates an example process for generating an adversarial testing scenario using offline reinforcement learning, according to some examples of the present disclosure;

FIG. 4 illustrates an example system environment that can be used to facilitate autonomous vehicle (AV) navigation and routing operations, according to some aspects of the disclosed technology; and

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Adversarial testing (also often referred to as “adaptive stress testing”) is a framework for finding the most likely path to a failure event in simulation. Adversarial testing of an AV is to find the most challenging driving scenario to test the AV in simulation so that how and when failures occur can be understood and the safety of AV in the real world can be validated.

Online reinforcement learning has been used to create an adversarial testing scenario that includes a scene that is most challenging to an AV and is likely to cause a failure of AV operation in stimulation. An online reinforcement learning agent has the ability to query a simulator about counterfactual scenarios (i.e., “what if” questions). More specifically, an online reinforcement learning agent can change the driving environment (i.e., certain scene features or actions) to run a counterfactual scenario-based simulation and see how the AV would react in the simulation. For example, an online reinforcement learning agent can query what would happen if a bicyclist on the scene was coming faster or a pedestrian on the scene walked towards the other way. A simulation system then can run a simulation of the counterfactual/what-if scenarios to test the behavior of an AV (e.g., a trajectory that would have been taken by an AV) in the counterfactual scenarios. An online reinforcement learning agent can learn from many iterations of actively querying a simulator until the most challenging driving scenario may be achieved for AV testing (e.g., until a safety critical event is most likely to occur in the driving scenario).

However, having a simulator constantly test in a simulation for counterfactual scenarios requires a large amount of simulation runs to train with the AV stack being executed in the loop. As follows, online reinforcement learning to optimize the elements of the scenario through simulation runs can be computationally expensive, especially if a high fidelity of the safety evaluation is needed. Furthermore, the evaluation based on simulation of the counterfactual scenarios can lack realism.

Aspects of the disclosed technology provide solutions for optimizing the generation of a driving scenario for AV adversarial test, and in particular, for optimizing the generation of a driving scenario for AV adversarial testing using offline reinforcement learning. In some aspects, the present technology can leverage the abundance of road data and existing simulation data for offline reinforcement learning. Given a driving scenario, adversarial testing using offline reinforcement learning can optimize elements of the scene (i.e., scene features or actions) to make the scene (e.g., driving environment, AV behavior, or driving scenario) more challenging and dangerous to the AV for testing.

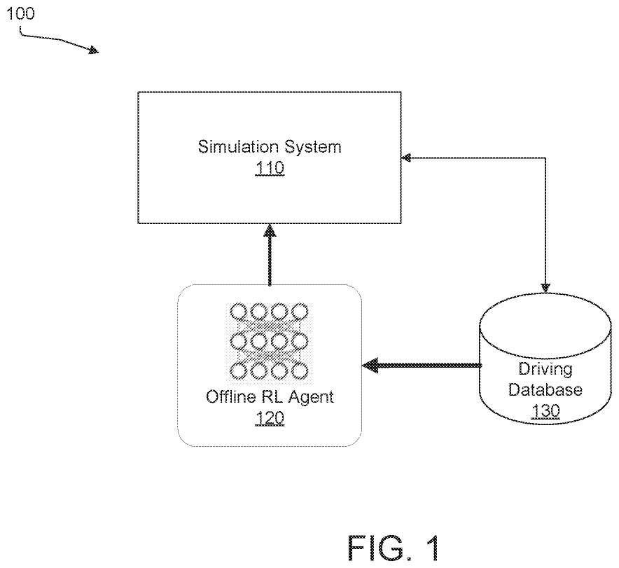

FIG. 1 illustrates an example of a simulation framework architecture 100, according to some aspects of the disclosed technology. Simulation framework architecture 100 includes simulation system 110, offline reinforcement learning (RL) agent (i.e., offline RL algorithm) 120, and driving database 130. In some aspects, simulation system 110 creates an adversarial test simulation scenario using offline reinforcement learning (e.g., with the use of offline RL agent 120) that utilizes previously collected data stored in driving database 130, without additional online data collection. Offline RL agent 120 can learn entirely from the previously collected data (i.e., static datasets) stored in driving database 130 and does not require a simulator for iterative counterfactual queries.

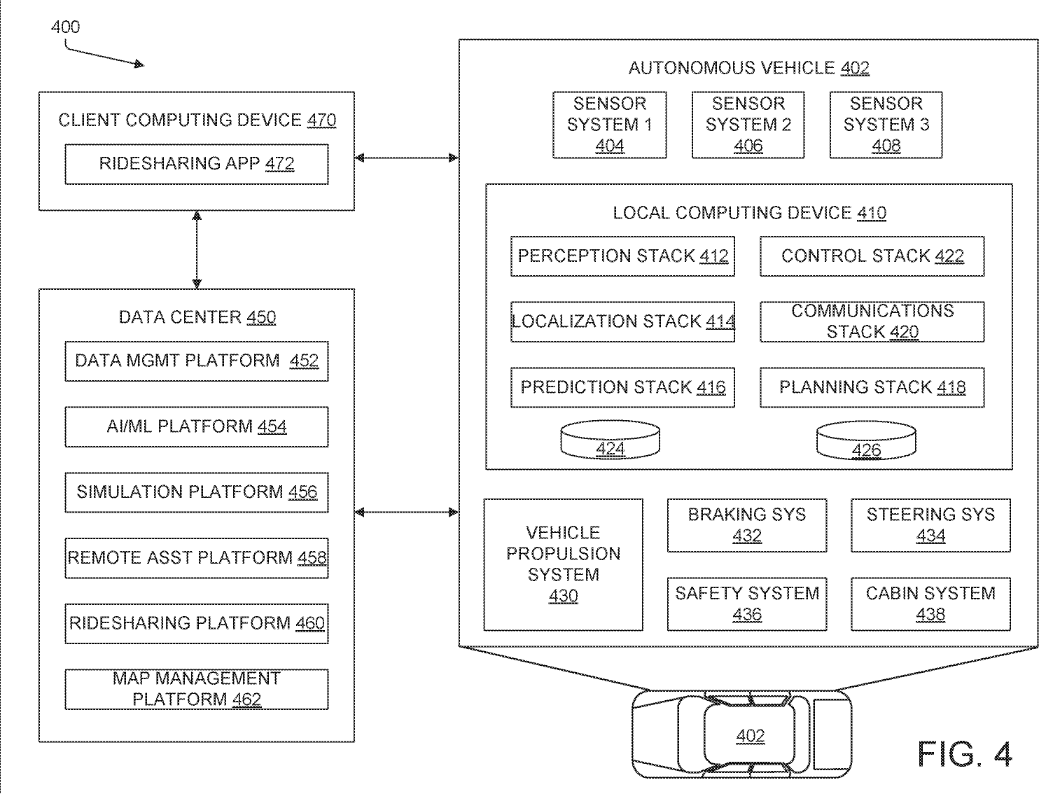

Simulation system 110 (similar to simulation platform 456 as illustrated in FIG. 4) is configured to generate a driving scenario that emulates a variety of driving environments and real-world scenes and/or scenarios based on various types of data available in driving database 130. For example, simulation system 110 can create simulations of situations encountered by an AV (e.g., AV 402 as illustrated in FIG. 4) based on data captured by the AV.

Driving database 130 (similar to data center 450 as illustrated in FIG. 4) can store various types of data generated by AV sensor systems (e.g., sensor systems 404-408 of FIG. 4), AV stacks (e.g. stacks 412-422 of FIG. 4), and any applicable AV components and/or data received by an AV from remote systems. In some aspects, AV data stored in driving database 130 can be used, for example, by simulation system 110, to create simulations for future AV testing. In some examples, AV data stored in driving database 130 can be used to train various machine learning algorithms such as a reinforcement learning algorithm (e.g., offline RL agent 120 of FIG. 1) as discussed below in detail.

Further, driving database 130 can store a plurality of collection sets, with each collection set including driving data generated by an AV (similar to AV 403 as illustrated in FIG. 4). As follows, driving database 130 can store an extensive amount of driving data that represents a plurality of driving scenarios encountered by multiple AVs while navigating on the road.

In some implementations, offline RL agent 120 is configured to learn from logged data, in other words, previously collected driving data stored in driving database 130 (i.e., static datasets). In contrast to online reinforcement learning that requires a simulator, offline RL agent 120 entirely relies on the logged data and does not require a simulator for counterfactual queries. Without interacting with the simulator (e.g., for simulation runs for counterfactual queries) and/or collecting additional data (e.g., new simulation data), offline RL agent 120 can learn the best policy from the static dataset.

By way of example, offline RL agent 120 can enable the logged data to be turned into generalizable decision-making engines, effectively turning the dataset into a policy that can optimize the elements (e.g., scene features or actions) of a driving scenario for adversarial testing. More specifically, a learned policy can optimize the elements to make the driving scenario adversarial or challenging for an AV in testing. For example, offline RL agent 120 is configured to learn near-optimal policies from previously collected data stored in driving database 130.

Reinforcement learning tasks can be framed as Markov Decision Process (MDP). In reinforcement learning formulation via MDP, an agent takes an action according to a policy (i.e., a function, which is most often provided by a deep neural network). The action is then applied to a simulator to generate a simulator state at the next time step. The state can be scored using a reward function that provides how desirable the state is. An update equation can use the reward to update the policy towards higher rewards. In other words, in the next time step, the agent will pick an action that leads to a higher reward. In offline reinforcement learning, rather than picking action(s) from the policy and the next state from the simulator, an offline reinforcement learning agent (e.g., offline RL agent 120) can play back what happened from the logged data (e.g., static datasets from driving database 130). An update equation for offline reinforcement learning compensates for the use of logged data rather than sampled data from the policy and simulator on the fly. The power of offline reinforcement learning to generalize away from the data relies on (1) the generalization ability of the neural networks; and (2) the update equations of reinforcement learning. By way of example for offline reinforcement learning for adversarial testing of an AV, an offline RL agent/algorithm (e.g., offline RL agent 120) can learn policies by playing back various driving scenarios from previously collected data (e.g., driving data stored in driving database 130) and optimizing scene features or actions on the scene that would make the driving environment in a driving scenario adversarial or challenging for an AV in testing, for example, that would result in an unsafe AV driving, a collision, or a safety critical event.

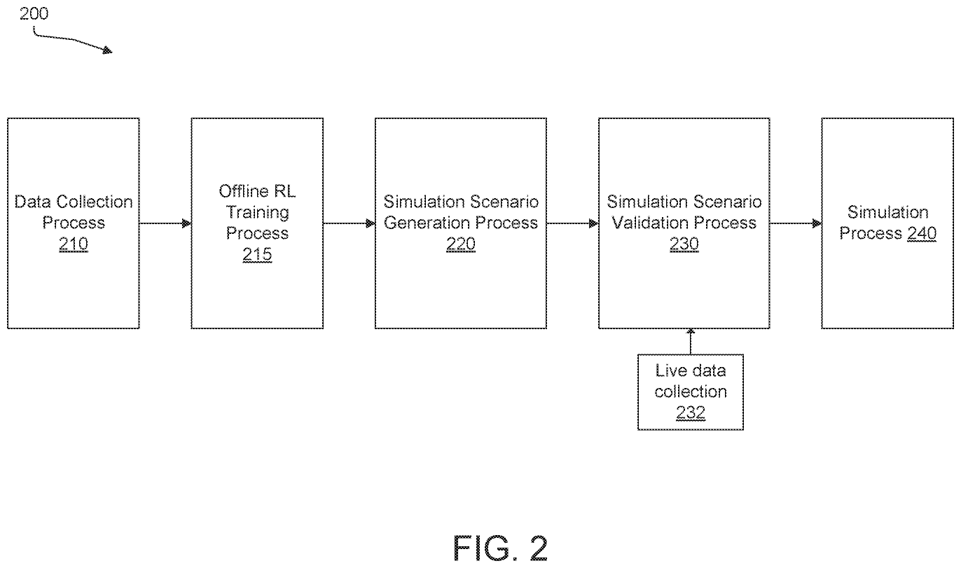

FIG. 2 illustrates a flow diagram of simulation scenario generation framework using reinforcement learning 200, according to some aspects of the disclosed technology. Simulation scenario generation framework 200 includes data collection process 210, offline reinforcement learning (RL) training process 215, simulation scenario generation process 220, simulation scenario validation process 230, and simulation process 240.

Data collection process 210 includes collecting and storing various types of data (collectively referred to as “driving data”) in AV database (e.g., driving database 130 as illustrated in FIG. 1 or data center 450 as illustrated in FIG. 4). By way of example, sensor data can be collected by various sensor systems (e.g., sensor systems 404-408 of AV 402 as illustrated in FIG. 4) of an AV and stored in the AV database. Non-limiting examples of sensor systems include a camera system, a LIDAR system, a RADAR system, ultrasonic sensor system, etc. The sensor data, typically captured during the navigation of an AV in real-time, is descriptive of the environment around an AV including geospatial information and various scene features such as road infrastructures, road segments, buildings, or other items or objects in the surrounding environment, or other dynamic elements (e.g., other vehicles, bicycles, pedestrians, etc.), direction of traffic lanes (e.g., the location and direction of a parking lane, a turning lane, a bicycle lane, or other lanes within a particular roadway or other travel way), traffic control data (e.g., the location and instructions of signage, traffic lights, or other traffic control devices).

In addition to sensor data, data collection process 210 includes collecting various types of data such as simulation data that may be generated from simulation runs of an AV (e.g., collected by simulation platform 456 as illustrated in FIG. 4), data received from remote systems (e.g., collected by remote assistance platform 458 as illustrated in FIG. 4), or any applicable type of data can be collected and saved in AV database (e.g., driving database 130 as illustrated in FIG. 1 or data center 450 as illustrated in FIG. 4). Further, data collecting process 210 includes collecting and storing a plurality of collection sets from multiple AVs, with each collection set including driving data captured by an AV.

In some implementations, the driving data collected and stored in a database can represent a plurality of driving scenarios encountered by one or more AVs while navigating on the road. In some examples, the collected data representing a plurality of driving scenarios can be used to train an offline reinforcement learning agent/algorithm at offline RL training process 215 as described below in detail. During data collection process 210, a large amount of driving data can be collected so that sufficient training data can be provided for offline RL training process 215.

Offline RL training process 215 includes training an offline RL agent/algorithm (e.g., offline RL agent 120 as illustrated in FIG. 1) with data that has been collected at data collection process 210. In other words, a database (e.g., driving database 130 as illustrated in FIG. 1) can be accessed to obtain the pre-collected driving data including a plurality of driving scenarios to be used as training data. The extensive amount of pre-collected driving data can provide sufficient training data for learning, especially without having to access additional dynamic live data (i.e., without direct access to or interaction with the environment as done in online reinforcement learning).

In some aspects, an offline reinforcement learning agent (e.g., offline RL agent 120 as illustrated in FIG. 2) can learn from the collected data and produce generalizable learned policies based on the collected data. The generalizable policies (i.e., trained policies, or trained model) may define the level of safety of various scene features and/or actions in driving environments. More specifically, training of an offline RL agent can generalize across the collected driving data to generate an offline reinforcement learning model that optimizes scene feature(s) and/or action(s) to cause an unsafe AV behavior and make a dangerous and challenging driving environment for AV adversarial testing.

Some examples of scene features and/or actions can include but are not limited to, the behavior of other vehicles or dynamic objects (e.g., pedestrians, jaywalkers, or strollers), a location and/or position of static or dynamic objects (e.g., hazardous objects) on the predicted trajectory of an AV, the timing of a traffic light change, the timing of a maneuver of other vehicles, the timing of cut-ins, weather conditions (e.g., rainy, snowy, foggy, clear, etc.), road conditions (e.g., ice patches, flooding, slipperiness, etc.), lighting conditions (e.g., poor light or glare, etc.) objects in an occluded view, hiding pedestrians, and/or a combination thereof. Example types of vehicles can include but are not limited to, cars, wagons, trucks, buses, motorcycles, bicycles, railed vehicles, watercraft, and/or aircraft.

By way of example, at offline RL training process 215, an offline reinforcement learning agent (e.g., offline RL agent 120 as illustrated in FIG. 1) can replay each of the driving scenarios represented in driving data (e.g., driving data stored in driving database 130 of FIG. 1) to train the offline RL agent/algorithm. More specifically, a plurality of scene features and actions can be identified by applying the offline RL algorithm to an initial state of the driving scenario. The offline RL algorithm can determine a reward prediction for each of the plurality of scene features and actions that would likely to result in an adversarial driving environment and scenario, solely based on the previously collected driving data. In other words, the offline RL algorithm can select an action (i.e., a scene features) for the next state that leads towards a higher reward (i.e., that would likely to cause an unsafe AV behavior and adversarial driving scenario).

Simulation scenario generation process 220 includes the generation of a simulation scenario for AV adversarial test. More specifically, a simulation scenario for AV adversarial testing can be generated using offline reinforcement learning to have a safety score that is lower than the safety score of the original driving scenario encountered by an AV in real-world.

In some examples, simulation scenario generation process 220 includes receiving a driving scenario from a database that stores driving data representing a driving scenario encountered by an AV. While database can store an extensive amount of driving data collected from multiple AVs, a driving scenario of interest, among the plurality of driving scenarios stored in the database, can be selected and provided for simulation scenario generation process 220.

Further, a safety score of the driving scenario can be calculated based on various factors that are present in the driving scenario such as presence or absence of a collision or safety critical event, time or distance to a collision if two actors had continued in their current trajectory, a degree of hard brakes/decelerations or swerves that has been taken or needed to be taken to avoid a collision, a type of the object(s) involved in a collision or safety critical event, a relative distance between two actors on the scene, weather conditions, road conditions, lighting conditions, and/or a combination thereof.

In some implementations, a driving scenario encountered by an AV (e.g., from driving database 130 as illustrated in FIG. 1 or from data collection process 210 as illustrated in FIG. 2) can be provided to an offline reinforcement learning model, which is generated by training an offline reinforcement learning algorithm with the collected driving data at offline RL training process 215. As previously described, an offline reinforcement learning agent (e.g., offline RL agent 120 as illustrated in FIG. 2) can determine one or more scene features based on generalized policies (e.g., learned from the driving data at offline RL training process 215) that would make the driving scenario more adversarial and challenging/dangerous for an AV. As follows, a simulation system (e.g., simulation system 110 as illustrated in FIG. 1 or simulation platform 452 as illustrated in FIG. 4) can generate a synthetic scenario that has a safety score that is lower than the safety score of the original driving scenario.

In some implementations, an offline reinforcement learning agent (e.g., offline RL agent 120) can identify a plurality of possible scene features in the driving scenario at each time stamp and select one or more of the plurality of possible scene features to make the driving scenario more adversarial/challenging, which is more likely to lead to a failure of operation of an AV in simulation. More specifically, the scene features can be optimized to make an AV behave in simulation, in a way to result in a low safety score. In some examples, the low safety score of the simulation can be evaluated by comparing it against a safety score of the driving scenario that was initially provided to the offline reinforcement learning model. An offline reinforcement learning agent selects the optimized scene features to be included in a synthetic scenario for simulating navigation of an AV that is more adversarial (i.e., that has a lower safety score) than the initial driving scenario. In other examples, the low safety score can be evaluated by comparing it against a threshold (i.e., a predetermined safety score) that is set as a safety baseline for adversarial testing.

Simulation scenario validation process 230 includes the validation of the simulation scenario for AV adversarial test. In some implementations, iteration of offline reinforcement learning can be used to validate the simulation scenario for AV adversarial test. For example, the simulation scenario generated at simulation scenario generation process 220 can be provided to an offline reinforcement learning model to verify that the simulation scenario has a lower safety score than the original driving scenario. In some aspects, the offline reinforcement learning can be iterated to generate an updated simulation scenario that has an even lower safety score or that is more challenging or dangerous for an AV.

In some aspects, online reinforcement learning can be applied to validate the simulation scenario for AV adversarial test. For example, offline reinforcement learning can be first applied to datasets to bootstrap the agent policies (i.e., simulation scenario generation process 220 that uses offline reinforcement learning), and then an active online simulation with live data collection 232 (e.g., dynamic datasets) can be used to fine-tune at simulation scenario validation process 230.

An online reinforcement learning agent can make counterfactual queries regarding the simulation scenario (e.g., scene features and/or actions in the simulation scenario) to determine if the safety score of the simulation scenario is lower than the safety score of the original driving scenario. Further, online reinforcement learning can be applied to generate an updated simulation scenario that has an even lower safety score or that is more challenging for an AV.

In some implementations, actor-critic RL algorithms can be used to learn the reinforcement learning model. An actor-critic RL algorithm can learn both a value function and a policy function. A policy function provides the action of the agent (e.g., how the pedestrian should behave in order to be most adversarial). A value function provides how valuable (e.g., how dangerous) the current state is. In other words, a value function can provide regions of high failure probability (i.e., dangerous or adversarial) in the state space. For example, in analyzing all possible states of a pedestrian, an actor-critic RL algorithm and model can determine where the dangerous/adversarial states are. In some examples, a state can include variables such as a position, speed, heading, or any applicable variable that describes the pedestrian at the current time stamp. As follows, a simplified application with only the policy evaluation component alone can give useful information about the safety landscape.

Simulation process 240 includes simulation of the navigation of an AV in the simulation scenario (e.g., generated at simulation scenario generation process 220 and validated at simulation scenario validation process 230) for an adversarial test. In some aspects, the simulation results in a failure of operation of an AV (e.g., sudden failure of vehicle operation, shutdown or breakdown of an engine, a flat tire, tire blowout, etc.), which indicates that an adversarial and challenging simulation scenario is provided. In other examples, the simulation leads to a safety critical event (e.g., a collision event, a near miss/near crash, or any crash-relevant event).

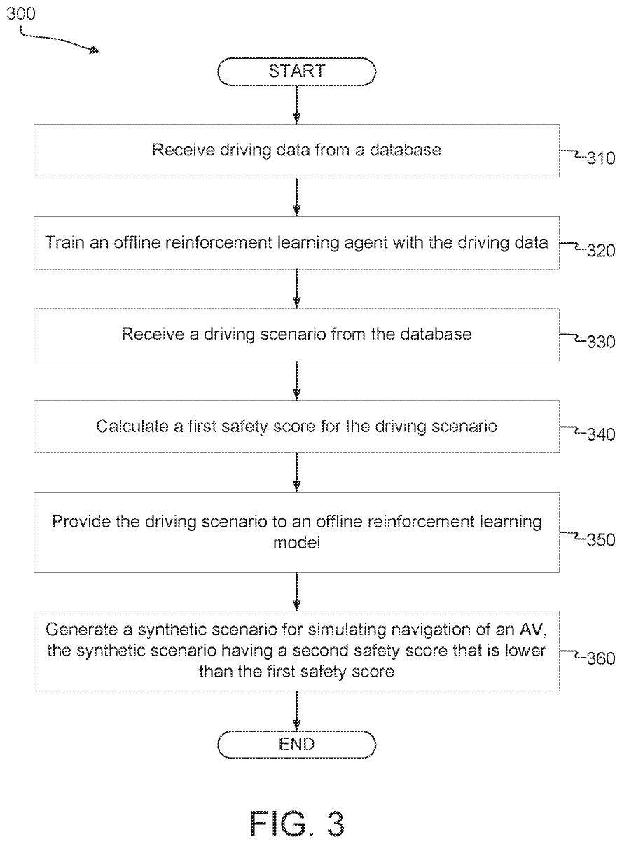

FIG. 3 illustrates a flowchart illustrating an example process 300 for generating an adversarial testing scenario using offline reinforcement learning. Although the example process 300 depicts a particular sequence of operations, the sequence may be altered without departing from the scope of the present disclosure. For example, some of the operations depicted may be performed in parallel or in a different sequence that does not materially affect the function of process 300. In other examples, different components of an example device or system that implements process 300 may perform functions at substantially the same time or in a specific sequence.

At step 310, process 300 includes receiving driving data from a database. The driving data can represent a plurality of driving scenarios encountered by one or more AVs. For example, simulation system 110 as illustrated in FIG. 1 can receive driving data from driving database 130 which stores driving data representing a plurality of driving scenarios encountered by one or more AVs while navigating on the road.

At step 320, process 300 includes training an offline reinforcement learning agent with the driving data. For example, simulation system 110 as illustrated in FIG. 1 can train offline RL agent 120 with the driving data from driving database 130.

At step 330, process 300 includes receiving a driving scenario from the database. For example, simulation system 110 as illustrated in FIG. 1 can receive a driving scenario from database 130 where the driving scenario is encountered by an AV (e.g., AV 402 as illustrated in FIG. 4).

At step 340, process 300 includes calculating a first safety score for the driving scenario. For example, simulation system 110 as illustrated in FIG. 1 can calculate a safety score of the driving scenario. A safety score can be a value that represents the measurement of “safety” based on various factors such as the presence of a collision or safety critical event, time or distance to a collision if two actors had continued in their current trajectory, a degree of hard brakes/decelerations or swerves that has been taken or needed to be taken to avoid a collision, a type of the object(s) involved in a collision or safety critical event, a relative distance between two actors, and/or a combination thereof.

At step 350, process 300 includes providing the driving scenario to an offline reinforcement learning model. For example, simulation system 110 as illustrated in FIG. 1 (or simulation platform 452 of FIG. 4) can provide the driving scenario to an offline reinforcement learning model which is generated by training offline reinforcement learning agent 120 as illustrated in FIG. 1.

At step 360, process 300 includes generating a synthetic scenario for simulating navigation of the AV. In some aspects, the synthetic scenario has a second safety score that is lower than the first safety score. For example, simulation system 110 as illustrated in FIG. 1 can generate a synthetic driving scenario for simulating the navigation of an AV (e.g., AV 402 as illustrated in FIG. 4). The synthetic scenario generated by simulation system 110 has a safety score that is lower than the safety score of the driving scenario (i.e., original driving scenario encountered by the AV, which was initially provided to the offline reinforcement learning model).

FIG. 4 is a diagram illustrating an example autonomous vehicle (AV) environment 400, according to some examples of the present disclosure. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include one or more types of sensors and can be arranged about the AV 402. For instance, the sensor systems 404-408 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other examples may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some examples, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 414 can determine the AV's position and orientation (pose) using different methods from multiple systems (e.g., GPS, IMUS, cameras, LIDAR, RADAR, ultrasonic sensors, the HD geospatial database 426, etc.). For example, in some cases, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some examples, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some examples, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 472. The client computing device 470 can be a customer's mobile computing device or a computing device integrated with the AV 402 (e.g., the local computing device 410). The ridesharing platform 4160 can receive requests to pick up or drop off from the ridesharing application 4172 and dispatch the AV 4102 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

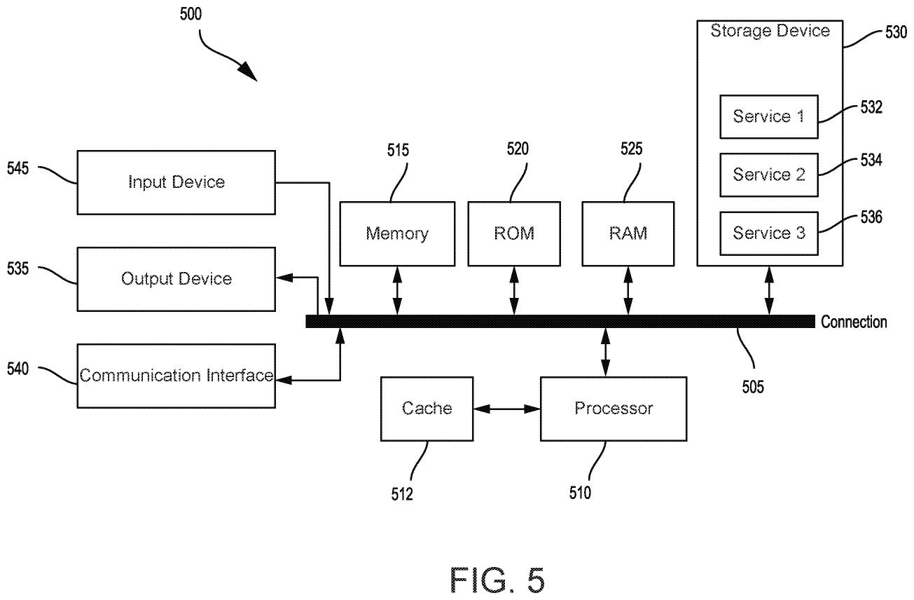

While the autonomous vehicle 402, the local computing device 410, and the autonomous vehicle environment 400 are shown to include certain systems and components, one of ordinary skill will appreciate that the autonomous vehicle 402, the local computing device 410, and/or the autonomous vehicle environment 400 can include more or fewer systems and/or components than those shown in FIG. 4. For example, the autonomous vehicle 402 can include other services than those shown in FIG. 4 and the local computing device 410 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 4. An illustrative example of a computing device and hardware components that can be implemented with the local computing device 410 is described below with respect to FIG. 5.

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAIVI/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: receiving driving data from a database, the driving data representing a plurality of driving scenarios encountered by one or more autonomous vehicles (AVs); training an offline reinforcement learning agent with the driving data; receiving a driving scenario from the database; calculating a first safety score for the driving scenario; providing the driving scenario to an offline reinforcement learning model; and generating a synthetic scenario for simulating navigation of an AV, the synthetic scenario having a second safety score that is lower than the first safety score.

Aspect 2. The method of Aspect 1, wherein training the offline reinforcement learning agent with the driving data includes: generalizing across the driving data to generate the offline reinforcement learning model that optimizes one or more scene features to cause an unsafe AV behavior in testing of the AV.

Aspect 3. The method of Aspects 1 and 2, wherein generating the synthetic scenario includes: identifying a plurality of possible scene features in the driving scenario; and selecting one or more of the plurality of possible scene features for the synthetic scenario based on a policy learned by the offline reinforcement learning agent from the driving data.

Aspect 4. The method of Aspects 1 through 3, wherein the selected one or more of the plurality of possible scene features cause a behavior of the AV that results in the second safety score that is lower than the first safety score.

Aspect 5. The method of Aspects 1 through 4, further comprising: validating that the second safety score is lower than the first safety score by providing the synthetic scenario to an online reinforcement learning model.

Aspect 6. The method of Aspects 1 through 5, further comprising: providing the synthetic scenario to an online reinforcement learning model; and generating an updated synthetic scenario having a third safety score that is lower than the second safety score.

Aspect 7. The method of Aspects 1 through 6, wherein the synthetic scenario includes a failure of operation of the AV.

Aspect 8. A system comprising: at least one memory; and at least one processor coupled to the at least one memory, the at least one processor configured to: receive driving data from a database, the driving data representing a plurality of driving scenarios encountered by one or more autonomous vehicles (AVs); train an offline reinforcement learning agent with the driving data; receive a driving scenario from the database; calculate a first safety score for the driving scenario; provide the driving scenario to an offline reinforcement learning model; and generate a synthetic scenario for simulating navigation of an AV, the synthetic scenario having a second safety score that is lower than the first safety score.

Aspect 9. The system of Aspect 8, wherein training the offline reinforcement learning agent with the driving data includes: generalizing across the driving data to generate the offline reinforcement learning model that optimizes one or more scene features to cause an unsafe AV behavior in testing of the AV.

Aspect 10. The system of Aspects 8 and 9, wherein generating the synthetic scenario includes: identifying a plurality of possible scene features in the driving scenario; and selecting one or more of the plurality of possible scene features for the synthetic scenario based on a policy learned by the offline reinforcement learning agent from the driving data.

Aspect 11. The system of Aspects 8 through 10, wherein the selected one or more of the plurality of possible scene features cause a behavior of the AV that results in the second safety score that is lower than the first safety score.

Aspect 12. The system of Aspects 8 through 11, wherein the at least one processor is configured to: validate that the second safety score is lower than the first safety score by providing the synthetic scenario to an online reinforcement learning model.

Aspect 13. The system of Aspects 8 through 12, wherein the at least one processor is configured to: provide the synthetic scenario to an online reinforcement learning model; and generate an updated synthetic scenario having a third safety score that is lower than the second safety score.

Aspect 14. The system of Aspects 8 through 13, wherein the synthetic scenario includes a failure of operation of the AV.

Aspect 15. A non-transitory computer-readable storage medium comprising at least one instruction for causing a computer or processor to: receive driving data from a database, the driving data representing a plurality of driving scenarios encountered by one or more autonomous vehicles (AVs); train an offline reinforcement learning agent with the driving data; receive a driving scenario from the database; calculate a first safety score for the driving scenario; provide the driving scenario to an offline reinforcement learning model; and generate a synthetic scenario for simulating navigation of an AV, the synthetic scenario having a second safety score that is lower than the first safety score.

Aspect 16. The non-transitory computer-readable storage medium of Aspect 15, wherein training the offline reinforcement learning agent with the driving data includes: generalizing across the driving data to generate the offline reinforcement learning model that optimizes one or more scene features to cause an unsafe AV behavior in testing of the AV.

Aspect 17. The non-transitory computer-readable storage medium of Aspects 15 and 16, wherein generating the synthetic scenario includes: identifying a plurality of possible scene features in the driving scenario; and selecting one or more of the plurality of possible scene features in the synthetic scenario based on a policy learned by the offline reinforcement learning agent from the driving data.

Aspect 18. The non-transitory computer-readable storage medium of Aspects 15 through 17, wherein the selected one or more of the plurality of possible scene features cause a behavior of the AV that results in the second safety score that is lower than the first safety score.

Aspect 19. The non-transitory computer-readable storage medium of Aspects 15 through 18, wherein the at least one instruction causes the computer or processor to: validate that the second safety score is lower than the first safety score by providing the synthetic scenario to an online reinforcement learning model.

Aspect 20. The non-transitory computer-readable storage medium of Aspects 15 through 19, wherein the at least one instruction causes the computer or processor to: provide the synthetic scenario to an online reinforcement learning model; and generate an updated synthetic scenario having a third safety score that is lower than the second safety score.

Aspect 21. A system comprising means for performing a method according to any of Aspects 1 through 7.

What is claimed is:

1. A method comprising:
receiving driving data from a database, the driving data representing a plurality of driving scenarios encountered by one or more autonomous vehicles (AVs);
training an offline reinforcement learning agent with the driving data;
receiving a driving scenario from the database;
calculating a first safety score for the driving scenario;
providing the driving scenario to an offline reinforcement learning model; and
generating a synthetic scenario for simulating navigation of an AV, the synthetic scenario having a second safety score that is lower than the first safety score.

2. The method of claim 1, wherein training the offline reinforcement learning agent with the driving data includes:
generalizing across the driving data to generate the offline reinforcement learning model that optimizes one or more scene features to cause an unsafe AV behavior in testing of the AV.

3. The method of claim 1, wherein generating the synthetic scenario includes:
identifying a plurality of possible scene features in the driving scenario; and
selecting one or more of the plurality of possible scene features for the synthetic scenario based on a policy learned by the offline reinforcement learning agent from the driving data.

4. The method of claim 3, wherein the selected one or more of the plurality of possible scene features cause a behavior of the AV that results in the second safety score that is lower than the first safety score.

5. The method of claim 1, further comprising:
validating that the second safety score is lower than the first safety score by providing the synthetic scenario to an online reinforcement learning model.

6. The method of claim 1, further comprising:
providing the synthetic scenario to an online reinforcement learning model; and
generating an updated synthetic scenario having a third safety score that is lower than the second safety score.

7. The method of claim 1, wherein the synthetic scenario includes a failure of operation of the AV.

8. A system comprising:
at least one memory; and
at least one processor coupled to the at least one memory, the at least one processor configured to:
receive driving data from a database, the driving data representing a plurality of driving scenarios encountered by one or more autonomous vehicles (AVs);
train an offline reinforcement learning agent with the driving data;
receive a driving scenario from the database;
calculate a first safety score for the driving scenario;
provide the driving scenario to an offline reinforcement learning model; and
generate a synthetic scenario for simulating navigation of an AV, the synthetic scenario having a second safety score that is lower than the first safety score.

9. The system of claim 8, wherein training the offline reinforcement learning agent with the driving data includes:
generalizing across the driving data to generate the offline reinforcement learning model that optimizes one or more scene features to cause an unsafe AV behavior in testing of the AV.

10. The system of claim 8, wherein generating the synthetic scenario includes:
identifying a plurality of possible scene features in the driving scenario; and
selecting one or more of the plurality of possible scene features for the synthetic scenario based on a policy learned by the offline reinforcement learning agent from the driving data.

11. The system of claim 10, wherein the selected one or more of the plurality of possible scene features cause a behavior of the AV that results in the second safety score that is lower than the first safety score.

12. The system of claim 8, wherein the at least one processor is configured to:
validate that the second safety score is lower than the first safety score by providing the synthetic scenario to an online reinforcement learning model.

13. The system of claim 8, wherein the at least one processor is configured to:
provide the synthetic scenario to an online reinforcement learning model; and
generate an updated synthetic scenario having a third safety score that is lower than the second safety score.

14. The system of claim 8, wherein the synthetic scenario includes a failure of operation of the AV.

15. A non-transitory computer-readable storage medium comprising at least one instruction for causing a computer or processor to:
receive driving data from a database, the driving data representing a plurality of driving scenarios encountered by one or more autonomous vehicles (AVs);
train an offline reinforcement learning agent with the driving data;
receive a driving scenario from the database;
calculate a first safety score for the driving scenario;
provide the driving scenario to an offline reinforcement learning model; and
generate a synthetic scenario for simulating navigation of the AV, the synthetic scenario having a second safety score that is lower than the first safety score.

16. The non-transitory computer-readable storage medium of claim 15, wherein training the offline reinforcement learning agent with the driving data includes:
generalizing across the driving data to generate the offline reinforcement learning model that optimizes one or more scene features to cause an unsafe AV behavior in testing of the AV.

17. The non-transitory computer-readable storage medium of claim 15, wherein generating the synthetic scenario includes:
identifying a plurality of possible scene features in the driving scenario; and
selecting one or more of the plurality of possible scene features for the synthetic scenario based on a policy learned by the offline reinforcement learning agent from the driving data.

18. The non-transitory computer-readable storage medium of claim 17, wherein the selected one or more of the plurality of possible scene features cause a behavior of the AV that results in the second safety score that is lower than the first safety score.

19. The non-transitory computer-readable storage medium of claim 15, wherein the at least one instruction causes the computer or processor to:
validate that the second safety score is lower than the first safety score by providing the synthetic scenario to an online reinforcement learning model.

20. The non-transitory computer-readable storage medium of claim 15, wherein the at least one instruction causes the computer or processor to:
provide the synthetic scenario to an online reinforcement learning model; and
generate an updated synthetic scenario having a third safety score that is lower than the second safety score.
